(19) United States
(12) Patent Application Publication
(10) Pub. No.: US 2008/0162243 A1
(43) Pub. Date: Jul. 3, 2008

(54) PERIPHERAL DEADLINE INDICATORS IN AN ACTIVITY-CENTRIC COLLABORATIVE COMPUTING ENVIRONMENT

(76) Inventors: Michael Muller, Medford, MA (US); Andrew L. Schirmer, Andover, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/618,444

(22) Filed: Dec. 29, 2006

(51) Int. Cl. G06Q 10/00

(52) U.S. Cl. 705/9

(57) ABSTRACT

Embodiments of the present invention address deficiencies of the art in respect to deadline management and real-time monitoring of task and event progress and provide a method, system and computer program product for providing peripheral deadline indicators for tasks and events. In one embodiment of the invention, a peripheral deadline indication system can include an operating system (O/S) user interface (UI) and multiple peripheral deadline indicators embedded into a control of the O/S UI. Each of the indicators can correspond to a different state for an impending, near term deadline and can include program code enabled to display an alert of deadline information for a corresponding impending, near term deadline in response to detecting a proximity event. The program code further can be enabled to display a deadline control pop-up of deadline information and deadline commands for a corresponding deadline in response to detecting a selection event.

### BACKGROUND OF THE INVENTION

1. Field of the Invention

The present invention relates to the field of collaborative computing and more particularly to tracking deadlines for activity objects in an activity-centric collaborative computing environment.

2. Description of the Related Art

Collaborative computing refers to the use by two or more end users of a computing application in order to achieve a common goal regardless of whether they are co-located or geographically dispersed or communicating synchronously or asynchronously. Initially envisioned as a document sharing technology among members of a small workgroup in the corporate environment, collaborative computing has grown today to include a wide variety of technologies arranged strategically to facilitate collaboration among groups as small as two people, or as large as a world-wide community. Thus, different collaborative applications may focus upon groups of different sizes. No longer merely restricted to document sharing, the modern collaborative environment can include document libraries, chat rooms, workflow, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, many goals and objectives can be achieved only through the participation of a multiplicity of individuals and systems, each serving a specified role or roles in the process. Consequently, to provide computing tools designed for use only by one of the individuals in the process can be short sighted and can ignore important potential contributions from among the other individuals involved in the process. It also might be counter productive to the individual and create more of a burden on the individual's workload requiring checking each system or tool, or checking-in with various people. This entails a lot of heavy lifting and a heavy cognitive load requiring one to remember each system, tool and person involved and to remember to check for updates and changes.

An activity-centric collaborative computing environment provides an enhanced form of the collaborative computing environment by enabling a task and activity paradigm for driving a collaborative goal for groups of collaborators on a project. In an activity-centric collaborative computing environment, a project can be viewed as a collection of different tasks and task-related work product and ad hoc communications arranged in a hierarchy providing a view to the entirety of the activity. Each node in the hierarchy can further be associated with one or more assigned roles. To the extent that any given node in the hierarchy is a task, the task can include an associated start date and a proposed duration such that the entire activity can be viewed as a project plan on a time line.

Different sub-trees of the hierarchy can represent discrete units of work to be achieved in driving a parent activity to completion. Referred to as an activity-thread, the progress of the associated roles in attending the events of an activity thread and of completing the tasks of the activity thread can be real-time monitored. When it appears that a collaborator is likely to miss a scheduled event or to fail to complete a task as scheduled, an alert can be issued in order to bring the impending or actual failure to the attention of the collaborator. To provide a more real-time view of task and event deadlines, a separate application such as a dashboard can be provided to track whether tasks and events are to proceed on schedule, or whether the tasks and events are unlikely to complete on schedule.

Notwithstanding, the enterprise dashboard approach to deadline management requires the use of a separate application which, if not utilized by the collaborator cannot provide critical deadline information. Additionally, to provide real-time status monitoring of all deadlines for an activity can result in an overwhelming number of tracked information and alerts for many different events and tasks in danger of falling off schedule. Finally, the coarse grained nature of real-time status monitoring for events provides to the end user substantial deadline information for later scheduled events and tasks at the expense of highlighting more critical, nearer term impending deadlines.

### BRIEF SUMMARY OF THE INVENTION

Embodiments of the present invention address deficiencies of the art in respect to deadline management and real-time monitoring of task and event progress and provide a method, system and computer program product for providing peripheral deadline indicators for tasks and events. In one embodiment of the invention, a peripheral deadline indication system can include an operating system (O/S) user interface (UI) and multiple peripheral deadline indicators embedded into a control of the O/S UI. Each of the indicators can correspond to a different state for an impending, near term deadline and can include program code enabled to display a alert of deadline information for a corresponding impending, near term deadline in response to detecting a proximity event. The program code further can be enabled to display a deadline control pop-up of deadline information and deadline commands for a corresponding deadline in response to detecting a selection event.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A and 1B, taken together, are a pictorial illustration of computing environment configured with peripheral deadline indicators for activity objects in an activity-centric collaborative computing environment;

FIG. 2 is an alternative pictorial illustration of computing environment configured with peripheral deadline indicators for activity objects in an activity-centric collaborative computing environment;

FIG. 3 is a schematic illustration of an activity-centric collaborative computing data processing system configured for peripheral deadline indicator management; and,

FIG. 4 is a flow chart illustrating a process for peripheral deadline indication management for activity objects in an activity-centric collaborative computing environment.

### DETAILED DESCRIPTION OF THE INVENTION

Embodiments of the present invention provide a method, system and computer program product for peripheral deadline indication management for activity objects in an activity-centric collaborative computing environment. In accordance with an embodiment of the present invention, peripheral deadline indicators, each corresponding to an impending, near term deadline can be placed in the operating system user interface. Each of the peripheral deadline indicators can indicate whether an impending, near term deadline has already been met, whether an impending, near term deadline is approaching, but not has not yet past, whether an impending, near term deadline is at risk of passing without resolution, or whether an already past, near term deadline has passed without resolution. In this way, an end user can identify via a quick glance the status of near term deadlines without launching a separate application and without becoming overwhelmed with alerts for all approaching deadlines irrespective of the temporal proximity of the deadline.

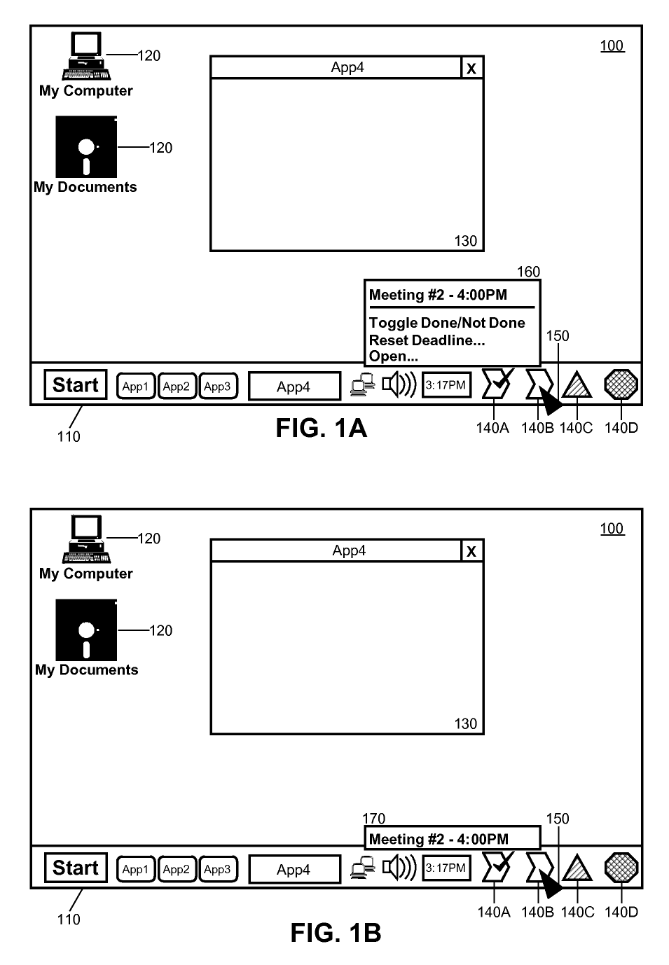

In illustration, FIGS. 1A and 1B, taken together, are a pictorial illustration of computing environment configured with peripheral deadline indicators for activity objects in an activity-centric collaborative computing environment. The computing environment can include an operating system user interface 100 configured to support the operation of a task bar 110. The operating system user interface 100 further can be configured to support the placement of iconic shortcuts 120 to applications hosted by the operating system. The task bar 110 can include an iconic indication of presently executing applications 130 along with other familiar accoutrements known universally to end users of the art.

Importantly, one or more peripheral deadline indicators 140A, 140B, 140C, 140D can be placed in the task bar 110. Each of the peripheral deadline indicators 140A, 140B, 140C, 140D can indicate whether an impending, near term deadline has already been met, whether an impending, near term deadline is approaching, but not has not yet past, whether an impending, near term deadline is at risk of passing without resolution, or whether an already past, near term deadline has passed without resolution. In this regard, only tasks or events scheduled for action within a short-term discrete period of time, such as a matter of hours or minutes are considered for association with a peripheral deadline indicator 140A, 140B, 140C, 140D. Other, longer term tasks or events scheduled for action after the short-term discrete period of time can be excluded from the peripheral deadline indicators 140A, 140B, 140C, 140D.

Referring specifically, to FIG. 1A, each of the peripheral deadline indicators 140A, 140B, 140C, 140D can be configured for proximity and selection event sensitivity. Specifically, as shown in FIG. 1A, the selection of one of the peripheral deadline indicators 140A, 140B, 140C, 140D can result in the display of a deadline control pop-up 160. The deadline control pop-up 160 can provide an information view to an associated scheduled event or task including the identity of the event or task and the time the event or task has been scheduled for action. The deadline control pop-up 160 also can provide access to several commands including toggling whether or not the associated event or task has been completed, resetting the deadline to a different time, and opening the task or event in its native application.

Aside from a selection event, the peripheral deadline indicators 140A, 140B, 140C, 140D can be configured for sensitivity to a proximity event such as a mouse over event. Referring to FIG. 1B, the placement in proximity of a mouse pointer 150 to a particular one of one of the peripheral deadline indicators 140A, 140B, 140C, 140D can result in the display of a deadline information tip 170. The deadline control tip 170 can provide an information view to an associated scheduled event or task including the identity of the event or task and the time the event or task has been scheduled for action. The deadline control tip 170 can remain visible for a set period of time before vanishing, or the deadline control tip 170 can remain visible for the duration of time the pointer 150 is in proximity to the particular one of one of the peripheral deadline indicators 140A, 140B, 140C, 140D.

In both instances, the deadline for an event can be the time when a task or event comes due. Alternatively, however, the deadline can account for the duration of time required to complete the task or event. In this regard, the deadline for a task or event can be computed as the time when the task or event comes due less the duration of time required for the end user to complete the task. Also, intervening tasks or appointments can be accounted for as the time consumed to complete an intervening task or event cannot be used in completing the task or event associated with the deadline. The corresponding one of the peripheral deadline indicators 140A, 140B, 140C, 140D can base its resulting state upon the modified deadline accounting for the requisite duration to complete the task or event.

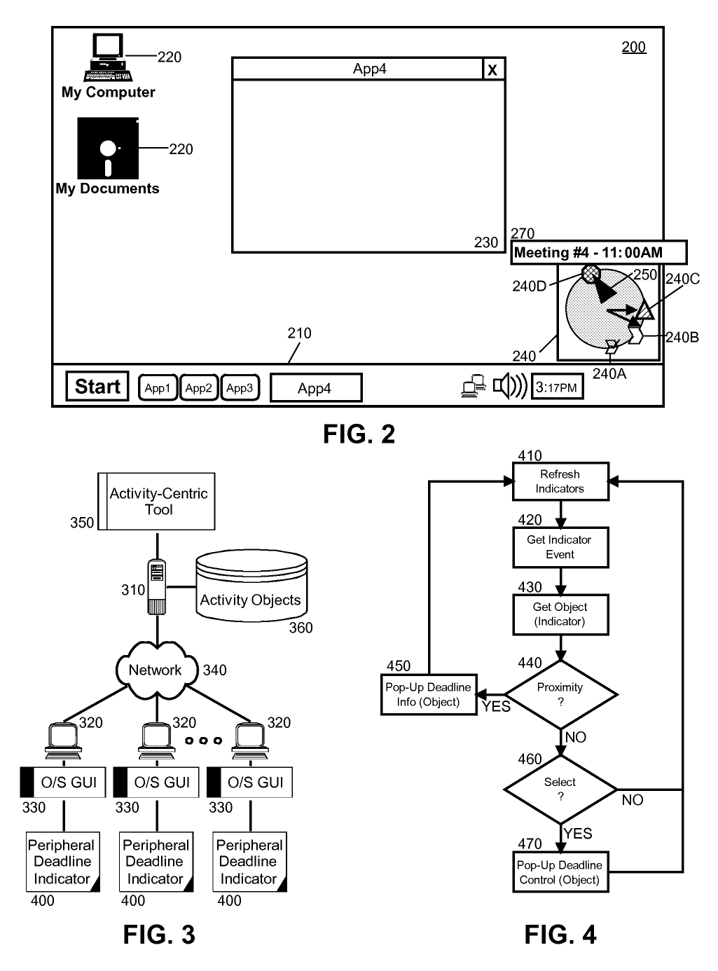

As an alternative to embedding the peripheral deadline indicators 140A, 140B, 140C, 140D in the task bar 110, the peripheral deadline indicators 140A, 140B, 140C, 140D can be rendered in a separate visual element of the operating system interface 100. For example, FIG. 2 is an alternative pictorial illustration of computing environment configured with peripheral deadline indicators for activity objects in an activity-centric collaborative computing environment. As shown in FIG. 2, the peripheral deadline indicators 240A, 240B, 240C, 240D can be disposed on a twenty-four (24) hour view 240 in the operating system interface 200 in proximity to the task bar 210 incorporating an iconic indication of presently executing applications 230 and the iconic shortcuts 220.

In addition to the visual indicators of FIGS. 1A, 1B, and 2, the peripheral indicators can be presented through other non-visual modalities, including audible modalities. In the latter instance, each deadline indicator can be associated with a tone of a specified pitch or frequency, and the tones of all of the deadline indicators can be played together as a chord or chime. Rapidly approaching deadlines can be signaled by a variation in the tone for the respective indicator, for example, the repeat sounding of the tone associated with that deadline indicator, or the playing of that tone at a higher volume, or resulting from a different waveform such as a square wave instead of sine wave.

Notably, the peripheral deadline indicators 240A, 240B, 240C, 240D can be included in the operating system interface 200 within a host computing client disposed in the larger, activity-centric collaborative computing context. In this regard, FIG. 3 is a schematic illustration of an activity-centric collaborative computing data processing system configured for peripheral deadline indicator management. The system can include a host computing platform 310 coupled to one or more computing clients 320 over computer communications network 340. The host computing platform 310 can support the operation of an activity-centric collaboration tool 350 managing the arrangement and use of one or more activity objects 360 including tasks and events associated with different collaborators interacting with the activity-centric collaboration tool 350 from the computing clients 320.

Each of the computing clients 320 can include an operating system graphical user interface (GUI) 330. Each GUI can include peripheral deadline indicators 400 disposed therein. The peripheral deadline indicators 400 can include program code enabled to detect proximity events and selection events. In response to detecting a proximity event, the program code of the peripheral indicators 400 can be enabled to display a deadline alert including summary deadline information for a deadline. By comparison, in response to detecting a selection event, the program code of the peripheral indicators 400 can be enabled to display a deadline control pop-up including summary deadline information for a deadline and corresponding commands for toggling the status of the deadline, for changing the deadline and for launching a view to a corresponding task or event in its native interface.

In yet further illustration of the operation of the peripheral deadline indicators 400, FIG. 4 is a flow chart illustrating a process for peripheral deadline indication management for activity objects in an activity-centric collaborative computing environment. Beginning in block 410, each peripheral indicator in the operating system interface can be refreshed to reflect a current status of a corresponding, impending, near-term deadline. The refreshing can include selecting an appropriate visual or audible representation of the current status. Thereafter, in block 420, an indicator event can be received, for instance a proximity event or a selection event.

In block 430, the activity object associated with the indicator can be retrieved, for example a task or event. In decision block 440, it can be determined whether the indicator event is a proximity event. If so, in block 450 a screen alert can be rendered with information for the deadline. Additionally, an audible indication of the status of the deadline can be provided. If not, the process can continue in decision block 460. In decision block 460, it can be determined whether the indicator event is a selection event. If so, in block 470 a deadline indicator control pop-up can be rendered. Thereafter, the process can repeat through block 410.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A peripheral deadline indication method comprising:
selecting a subset of impending, near term deadlines for corresponding activity objects in an activity-centric collaborative computing environment;
placing individual peripheral deadline indicators within an operating system interface hosting a view to the activity-centric collaborative computing environment, each of the individual peripheral deadline indicators corresponding to one of the deadlines in the subset;
receiving a proximity event in association with a particular one of the peripheral deadline indicators; and,
rendering an alert display with information pertaining to a deadline corresponding to the particular one of the peripheral deadline indicators.

2. The method of claim 1, further comprising:
playing a periodic set of auditory signals, one of the signals for each of the peripheral deadline indicators; and,
presenting a variation in a particular one of the auditory signals associated with the particular one of the peripheral deadline indicators receiving the proximity event.

3. The method of claim 1, further comprising:
receiving a selection event in association with a particular one of the peripheral deadline indicators; and,
rendering a deadline control pop-up both tip with information pertaining to deadline corresponding to the particular one of the peripheral deadline indicators, and also at least one command pertaining to controlling the deadline.

4. The method of claim 1, further comprising:
determining a required time interval for an action associated with a particular one of the near term deadlines; and,
modifying the particular one of the near term deadlines to account for the required time interval.

5. The method of claim 4, further comprising:
identifying a required time interval for a different near term deadline preceding the particular one of the near term deadlines; and,
additionally modifying the particular one of the near term deadlines to account not only for the required time interval for the action, but also the required time interval for the different near term deadline preceding the particular one of the near term deadlines.

6. The method of claim 1, wherein selecting a subset of impending, near term deadlines for corresponding activity objects in an activity-centric collaborative computing environment, comprises identifying a subset of deadlines each scheduled to occur with a discrete, near term number of hours.

7. The method of claim 1, wherein placing individual peripheral deadline indicators within an operating system interface hosting a view to the activity-centric collaborative computing environment, comprises placing individual peripheral deadline indicators about a clock view disposed within an operating system interface.

8. The method of claim 1, wherein receiving a proximity event in association with a particular one of the peripheral deadline indicators, comprises receiving a mouse over event in association with a particular one of the peripheral deadline indicators.

9. A peripheral deadline indication data processing system comprising:
an operating system user interface;
a plurality of peripheral deadline indicators embedded into a control of the operating system user interface, each of the indicators corresponding to a different state for an impending, near term deadline; and,
program code coupled to the indicators, the program code being enabled to display a alert of deadline information for a corresponding impending, near term deadline in response to detecting a proximity event.

10. The system of claim 9, wherein the control is a task bar.

11. The system of claim 9, wherein the control is a clock view placed in a desktop portion of the operating system user interface.

12. The system of claim 9, wherein the different state comprises a state selected from the group consisting of whether an impending, near term deadline has already been met, whether an impending, near term deadline is approaching, but not has not yet past, whether an impending, near term deadline is at risk of passing without resolution, or whether an already past, near term deadline has passed without resolution.

13. The system of claim 9, wherein the program code is further enabled to display a deadline control pop-up of deadline information and deadline commands for a corresponding impending, near term deadline in response to detecting a selection event.

14. A computer program product comprising a computer usable medium embodying computer usable program code for peripheral deadline indication, the computer program product comprising:
computer usable program code for selecting a subset of impending, near term deadlines for corresponding activity objects in an activity-centric collaborative computing environment;
computer usable program code for placing individual peripheral deadline indicators within an operating system interface hosting a view to the activity-centric collaborative computing environment, each of the individual peripheral deadline indicators corresponding to one of the deadlines in the subset;
computer usable program code for receiving a proximity event in association with a particular one of the peripheral deadline indicators; and,
computer usable program code for rendering an alert display with information pertaining to a deadline corresponding to the particular one of the peripheral deadline indicators.

15. The computer program product of claim 14, further comprising:
computer usable program code for playing a periodic set of auditory signals, one of the signals for each of the peripheral deadline indicators; and,
computer usable program code for presenting a variation in a particular one of the auditory signals associated with the particular one of the peripheral deadline indicators receiving the proximity event.

16. The computer program product of claim 14, further comprising:
computer usable program code for receiving a selection event in association with a particular one of the peripheral deadline indicators; and,
computer usable program code for rendering a deadline control pop-up both tip with information pertaining to deadline corresponding to the particular one of the peripheral deadline indicators, and also at least one command pertaining to controlling the deadline.

17. The computer program product of claim 14, further comprising:
computer usable program code for determining a required time interval for an action associated with a particular one of the near term deadlines; and,
computer usable program code for modifying the particular one of the near term deadlines to account for the required time interval.

18. The method of claim 17, further comprising:
computer usable program code for identifying a required time interval for a different near term deadline preceding the particular one of the near term deadlines; and,
computer usable program code for additionally modifying the particular one of the near term deadlines to account not only for the required time interval for the action, but also the required time interval for the different near term deadline preceding the particular one of the near term deadlines.

19. The computer program product of claim 14, wherein the computer usable program code for selecting a subset of impending, near term deadlines for corresponding activity objects in an activity-centric collaborative computing environment, comprises computer usable program code for identifying a subset of deadlines each scheduled to occur with a discrete, near term number of hours.

20. The computer program product of claim 14, wherein the computer usable program code for placing individual peripheral deadline indicators within an operating system interface hosting a view to the activity-centric collaborative computing environment, comprises computer usable program code for placing individual peripheral deadline indicators about a clock view disposed within an operating system interface.

21. The computer program product of claim 14, wherein the computer usable program code for receiving a proximity event in association with a particular one of the peripheral deadline indicators, comprises computer usable program code for receiving a mouse over event in association with a particular one of the peripheral deadline indicators.
